(19) United States
(12) Patent Application Publication
(10) Pub. No.: US 2021/0365471 A1
(43) Pub. Date: Nov. 25, 2021

(54) GENERATING INSIGHTS BASED ON NUMERIC AND CATEGORICAL DATA

(71) Applicant: BUSINESS OBJECTS SOFTWARE LTD., Dublin (IE)

(72) Inventors: Paul O'Hara, Dublin (IE); Robert McGrath, Ranelagh (IE); Ying Wu, Maynooth (IE); Shekhar Chhabra, Dublin (IE); Eoin Goslin, Dublin (IE); Pat Connaughton, Dublin (IE); John Bowden, Dublin (IE); Alan Maher, Roscommon (IE); David Hutchinson, Dublin (IE); Leanne Long, Dublin (IE); Malte Christian Kaufmann, Clonskeagh (IE); Pukhraj Saxena, Dublin (IE); Priti Mulchandani, Dublin (IE); Anirban Banerjee, Kilcullen (IE)

(21) Appl. No.: 16/877,909

(22) Filed: May 19, 2020

(51) Int. Cl. G06F 16/26; G06F 16/28; G06F 16/2458

(52) U.S. Cl. CPC G06F 16/26; G06F 16/2465; G06F 16/285

(57) ABSTRACT

The present disclosure involves systems, software, and computer implemented methods for generating insights based on numeric and categorical data. One example method includes receiving a request for an insight analysis for a dataset that includes at least one continuous feature and at least one categorical feature. Continuous features can have any value within a range of numerical values and categorical features are enumerated features that can have a value from a predefined set of values. A selection of a first continuous feature for analysis is received, and at least one categorical feature is identified for analysis. A deviation factor and a relationship factor are determined for each identified categorical feature. An insight score is determined for each identified categorical feature that combines the deviation factor and the relationship factor for the categorical feature. The insight score is provided for at least some of the identified categorical features.

### TECHNICAL FIELD

The present disclosure relates to computer-implemented methods, software, and systems for generating insights based on numeric and categorical data.

### BACKGROUND

An analytics platform can help an organization with decisions. Users of an analytics application can view data visualizations, see data insights, or perform other actions. Through use of data visualizations, data insights, and other features or outputs provided by the analytics platform, organizational leaders can make more informed decisions.

### SUMMARY

The present disclosure involves systems, software, and computer implemented methods for generating insights based on numeric and categorical data. An example method includes: receiving a request for an insight analysis for a dataset, wherein the dataset includes at least one continuous feature and at least one categorical feature, wherein continuous features are numerical features that represent features that can have any value within a range of values and wherein categorical features are enumerated features that can have a value from a predefined set of values; receiving a selection of a first continuous feature for analysis; identifying at least one categorical feature for analysis; determining, for each identified categorical feature, a deviation factor that represents a level of deviation in the dataset between categories of the categorical feature in relation to the continuous feature; determining, for each identified categorical feature, a relationship factor that represents a level of informational relationship between the categorical and continuous feature; determining, based on the determined deviation factors and the determined relationship factors, an insight score, for each identified categorical feature, that combines the deviation factor and the relationship factor for the categorical feature; and providing the insight score for at least some of the identified categorical features.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for generating insights based on numeric and categorical data.

FIG. 2 illustrates an example architecture of an insight framework.

FIG. 3 illustrates an example feature selector.

FIG. 4 illustrates an example deviation factor calculator.

FIG. 5 illustrates an example relationship factor calculator.

FIG. 6 illustrates an example insight incorporator.

FIGS. 7A, 8A, 9A, 10A, and 11A illustrate respective count per category graphs and continuous feature value sum per category graphs for respective example datasets.

FIGS. 7B, 8B, 9B, 10B, and 11B illustrate respective continuous feature distribution per category graphs for respective example datasets.

FIGS. 7C, 8C, 9C, 10C, and 11C illustrate respective tables that include insight algorithm results when executed on example datasets.

FIG. 12 is a flowchart of an example method for generating insights based on numeric and categorical data.

### DETAILED DESCRIPTION

The volume of available data collected and stored by organizations is constantly increasing, which can result in time-consuming or even infeasible attempts by users to understand all of the data. Data mining techniques can be used to help users better handle significant amounts of data. However, challenges can exist when using data mining algorithms and techniques.

For instance, data mining can be affected by the quality of data. As another example, efficiency of data mining can be considered, since the efficiency and scalability of data mining can depend on the efficiency of algorithms and techniques. As data amounts continue to multiply, efficiency and scalability can become critical. If algorithms and techniques are inefficiently designed, the data mining experience and scalability can be adversely affected, impacting algorithm adoption. Additionally, for some data mining approaches, the data mining of massive datasets may require multiple methods to be applied, the facilitating of data to be viewed from multiple perspectives, and the extracting of insights and knowledge. Often, an organization may have a shortage of users with the pre-requisite knowledge and expertise required to harness algorithms in unison with the data to extract valuable knowledge and insights.

Accordingly, a desired data mining algorithm can be one that is efficient, scalable, applicable without requiring significant algorithm knowledge or expertise, and easily interpretable by users. For example, an insight framework can be used which can at least partially automate the process of discovering knowledge and insights though constraint guided mining. Specifically, a continuous feature of a dataset can be selected, and behavioral and informational relationships between the continuous feature and one or more categorical features of the dataset can be determined.

The insight framework can efficiently discover interesting insights identifying deviational behavior within the categorical features based on the selected continuous feature, while gathering knowledge towards each categorical features' informational relationship with the continuous feature. The underlying algorithm provided by the framework can integrate the produced insights and knowledge to output an insight score per categorical feature. The insight score can enable the ranking of categorical features relative to the continuous feature. The output from the framework can increase knowledge regarding the selected continuous feature, with the discovered knowledge capable of being utilized in further analysis.

In summary, the framework can provide an algorithm that can produce an insight score indicating a ranked relationship between a continuous feature and categorical feature(s), incorporating mined deviation knowledge. The framework can be a generic framework that can semi-automate a knowledge extraction process through constraint guided mining. Framework outputs can be interpretable by users without significant algorithm knowledge or expertise.

The framework algorithm(s) can be efficient and scalable. For instance, a cloud native algorithm and framework can be capable of efficiently mining knowledge on massive amounts of data, scaling in a reasonable manner as the number of categorical features increase. A cloud native architecture can make the framework inherently scalable and applicable to massive concurrent parallel execution, enabling the framework to process multiple categorical features in parallel without impacting efficiency.

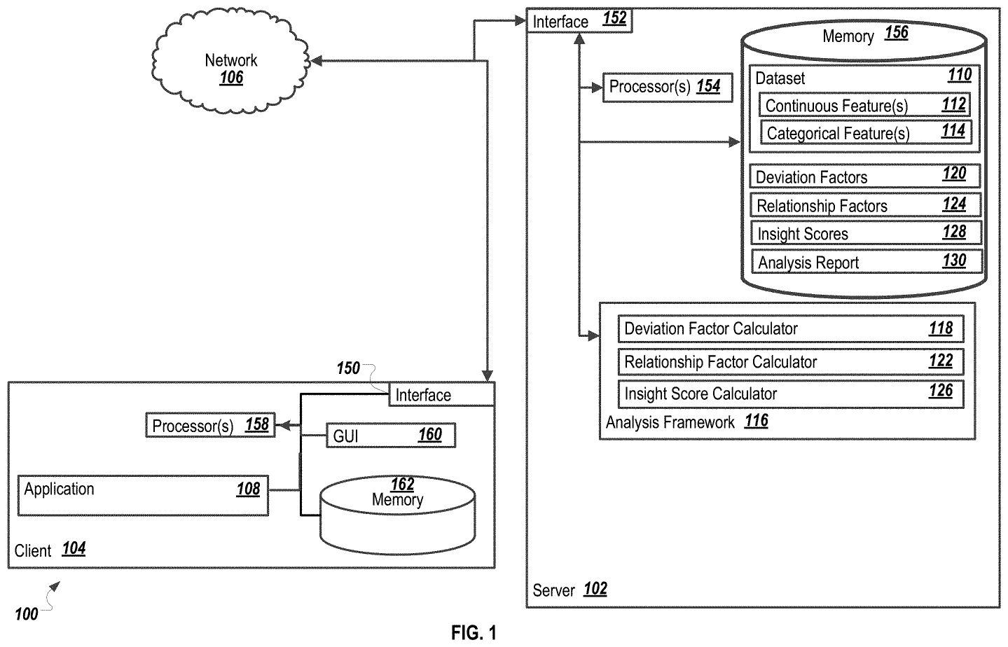

FIG. 1 is a block diagram illustrating an example system 100 for generating insights based on numeric and categorical data. Specifically, the illustrated system 100 includes or is communicably coupled with a server 102, a client device 104, and a network 106. Although shown separately, in some implementations, functionality of two or more systems or servers may be provided by a single system or server. In some implementations, the functionality of one illustrated system, server, or component may be provided by multiple systems, servers, or components, respectively. Although one server 102 is illustrated, the server 102 can embody a cloud platform that includes multiple servers, for example.

The system 100 can provide an efficient, scalable, and interpretable data mining solution that extracts useful information, insights, and knowledge for an organization. The system 100 can provide solutions that at least partially automate a process of knowledge and discovery and insight extraction, through a constraint guided data mining process.

For instance, a user of the client device 104 can use an application 108 to send a request for an insight analysis to the server 102. The request can be to perform an insight analysis on a dataset 110 that is either stored at or accessible by the server 102. The dataset 110 can include continuous feature(s) 112 and categorical feature(s), and the user can select a continuous feature 112 using the application 108, for example, for analysis. The user can select a subset of categorical feature(s) 114 or can accept a default of having all categorical features 114 analyzed. The selected continuous feature 112 and the selected (or defaulted) categorical features 114 can constrain the data mining analysis (e.g., other non-selected continuous features 112 or categorical features 114 can be omitted from analysis).

A continuous feature 112 can be defined as numeric data in which (conceptually) any numeric value within a specified range may be a valid value. An example of a continuous feature 112 is temperature. In some cases, a continuous feature 112 may be a numerical feature for which an aggregation of the values may be any numeric value within a specified range of values. For instance, a feature may be ages, wage amounts, or counts of some item (which, for example, may be whole numbers), but averages or other aggregations of these features (e.g., over time) can be floating point numbers that can have any value (subject to limitations of a particular floating point precision used in a physical implementation). Accordingly, features such as age, dollar amounts, or counts may be considered continuous.

Categorical features 114 can be defined as data in which values are available from a predefined set of possible category values. Category values can be items in a predefined enumeration of values, for example. Categorical data may be ordered (e.g., days of week) or unordered (e.g., gender).

Once a continuous feature 112 is selected, an analysis framework 116 can extract behavioral and informational relationship information between the continuous feature 112 and categorical features 114 that exist within the dataset 110. For example, a deviation factor calculator 118 can discover insights by identifying deviational behavior (represented as deviation factors 120) for the categorical features 114 based on the selected continuous feature 112. A higher amount of deviation for a categorical feature 114 can indicate a more interesting feature, as compared to categorical features 114 that have less deviation.

In addition to analyzing for deviation, the analysis framework 116 can, using a relationship factor calculator 122, determine relational information that may exist between the categorical feature 114 and the continuous feature 112. Relationship factors 124 can indicate how good a categorical feature 114 is (e.g., on average) at predicting values of the continuous feature 112.

An insight score calculator 126 can combine deviation factors 120 and corresponding relationship factors 124 to determine insight scores 128 for each categorical feature 114. A higher insight score 128 can indicate a higher level of insight (e.g., more interest) for a categorical feature 114. Accordingly, categorical features 114 can be ranked by their insight scores 128. Categorical features 114 that have both a relatively high deviation factor 120 and a relatively high relational factor 124 will generally have higher insight scores 128 than categorical features 114 that have either a lower deviation factor 120 or a lower relational factor 124 (or low values for both scores).

An analysis report 130 that includes ranked insight scores 128 for analyzed categorical features 114 and the selected continuous feature 112 can be sent to the client device 104 for presentation in the application 108. In some cases, only highest ranked score(s) or a set of relatively highest ranked scores are provided. In general, insight scores 128 can be provided to users and/or can be provided to other systems (e.g., to be used in other data mining or machine learning processes).

The system 100 can be configured for efficiency, scalability, and parallelization. For instance, an efficiency level can be maintained even as a size of the dataset 110 (or other datasets) grows. A cloud native architecture can be used for the system 100, which can provide scalability and enable, for example, massively concurrent parallelization. For instance, rather than have categorical features processed in sequence, different servers, systems, or components can process categorical features 114 in parallel and provide insight scores 128 to the analysis framework 116 (which can be implemented centrally), which can rank categorical features 114 by insight scores 128 once insight scores 128 have been received. The deviation factor calculator 118, the relationship factor calculator 122, and the insight score calculator 126 can be implemented on multiple different nodes, for example.

As used in the present disclosure, the term “computer” is intended to encompass any suitable processing device. For example, although FIG. 1 illustrates a single server 102, and a single client device 104, the system 100 can be implemented using a single, stand-alone computing device, two or more servers 102, or two or more client devices 104. Indeed, the server 102 and the client device 104 may be any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server 102 and the client device 104 may be adapted to execute any operating system, including Linux, UNIX, Windows, Mac OS®, Java™, Android™, iOS or any other suitable operating system. According to one implementation, the server 102 may also include or be communicably coupled with an e-mail server, a Web server, a caching server, a streaming data server, and/or other suitable server.

Interfaces 150 and 152 are used by the client device 104 and the server 102, respectively, for communicating with other systems in a distributed environment—including within the system 100—connected to the network 106. Generally, the interfaces 150 and 152 each comprise logic encoded in software and/or hardware in a suitable combination and operable to communicate with the network 106. More specifically, the interfaces 150 and 152 may each comprise software supporting one or more communication protocols associated with communications such that the network 106 or interface's hardware is operable to communicate physical signals within and outside of the illustrated system 100.

The server 102 includes one or more processors 154. Each processor 154 may be a central processing unit (CPU), a blade, an application specific integrated circuit (ASIC), a field-programmable gate array (FPGA), or another suitable component. Generally, each processor 154 executes instructions and manipulates data to perform the operations of the server 102. Specifically, each processor 154 executes the functionality required to receive and respond to requests from the client device 104, for example.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java™, JavaScript®, Visual Basic, assembler, Perl®, any suitable version of 4GL, as well as others. While portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

The server 102 includes memory 156. In some implementations, the server 102 includes multiple memories. The memory 156 may include any type of memory or database module and may take the form of volatile and/or non-volatile memory including, without limitation, magnetic media, optical media, random access memory (RAM), read-only memory (ROM), removable media, or any other suitable local or remote memory component. The memory 156 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server 102.

The client device 104 may generally be any computing device operable to connect to or communicate with the server 102 via the network 106 using a wireline or wireless connection. In general, the client device 104 comprises an electronic computer device operable to receive, transmit, process, and store any appropriate data associated with the system 100 of FIG. 1. The client device 104 can include one or more client applications, including the application 108. A client application is any type of application that allows the client device 104 to request and view content on the client device 104. In some implementations, a client application can use parameters, metadata, and other information received at launch to access a particular set of data from the server 102. In some instances, a client application may be an agent or client-side version of the one or more enterprise applications running on an enterprise server (not shown).

The client device 104 further includes one or more processors 158. Each processor 158 included in the client device 104 may be a central processing unit (CPU), an application specific integrated circuit (ASIC), a field-programmable gate array (FPGA), or another suitable component. Generally, each processor 158 included in the client device 104 executes instructions and manipulates data to perform the operations of the client device 104. Specifically, each processor 158 included in the client device 104 executes the functionality required to send requests to the server 102 and to receive and process responses from the server 102.

The client device 104 is generally intended to encompass any client computing device such as a laptop/notebook computer, wireless data port, smart phone, personal data assistant (PDA), tablet computing device, one or more processors within these devices, or any other suitable processing device. For example, the client device 104 may comprise a computer that includes an input device, such as a keypad, touch screen, or other device that can accept user information, and an output device that conveys information associated with the operation of the server 102, or the client device 104 itself, including digital data, visual information, or a GUI 160.

The GUI 160 of the client device 104 interfaces with at least a portion of the system 100 for any suitable purpose, including generating a visual representation of the application 108. In particular, the GUI 160 may be used to view and navigate various Web pages, or other user interfaces. Generally, the GUI 160 provides the user with an efficient and user-friendly presentation of business data provided by or communicated within the system. The GUI 160 may comprise a plurality of customizable frames or views having interactive fields, pull-down lists, and buttons operated by the user. The GUI 160 contemplates any suitable graphical user interface, such as a combination of a generic web browser, intelligent engine, and command line interface (CLI) that processes information and efficiently presents the results to the user visually.

Memory 162 included in the client device 104 may include any memory or database module and may take the form of volatile or non-volatile memory including, without limitation, magnetic media, optical media, random access memory (RAM), read-only memory (ROM), removable media, or any other suitable local or remote memory component. The memory 162 may store various objects or data, including user selections, caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client device 104.

There may be any number of client devices 104 associated with, or external to, the system 100. For example, while the illustrated system 100 includes one client device 104, alternative implementations of the system 100 may include multiple client devices 104 communicably coupled to the server 102 and/or the network 106, or any other number suitable to the purposes of the system 100. Additionally, there may also be one or more additional client devices 104 external to the illustrated portion of system 100 that are capable of interacting with the system 100 via the network 106. Further, the term “client”, “client device” and “user” may be used interchangeably as appropriate without departing from the scope of this disclosure. Moreover, while the client device 104 is described in terms of being used by a single user, this disclosure contemplates that many users may use one computer, or that one user may use multiple computers.

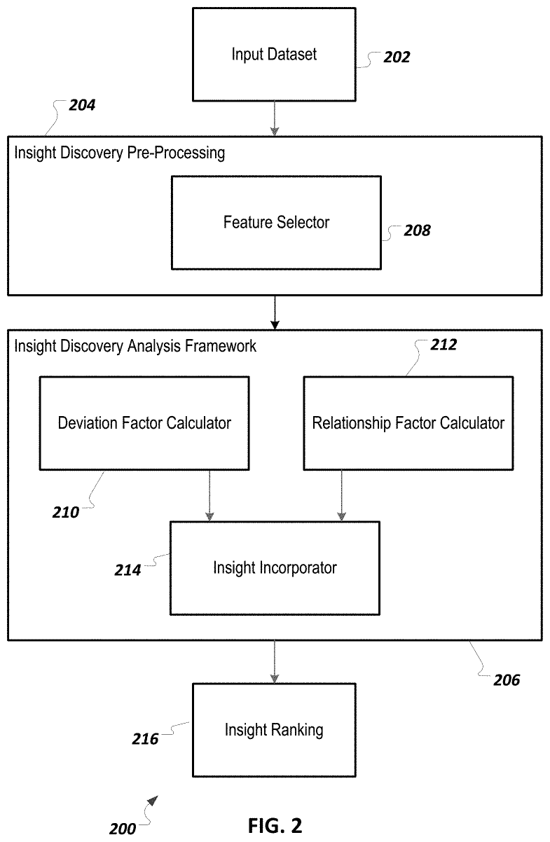

FIG. 2 illustrates an example architecture 200 of an insight framework. An input dataset 202 used by the framework can be a dataset that includes at least one continuous feature and at least one categorical feature. The architecture 200 includes an insight discovery pre-processing component 204 and an insight discovery analysis framework 206.

The insight discovery pre-processing component 204 can be used to filter the input dataset 202, thereby guiding a knowledge extraction process. The insight discovery pre-processing component 204 includes a feature selector 208. The feature selector 208 can be used to filter the input dataset 202 by identifying a continuous feature for constrained data mining to be applied against and categorical feature(s) for which insight discovery analysis is to be performed. The selected continuous feature and the selected categorical feature(s) can be provided to the insight discovery analysis framework 206.

The insight discovery analysis framework 206 includes a deviation factor calculator 210, a relationship factor calculator 212, and an insight incorporator 214. The deviation factor calculator 210 can be applied to the selected dataset features to calculate a factor for each selected categorical feature that represents a level of deviation that exists between the categorical feature items (e.g., categories) of the categorical feature in relation to the continuous feature. The relationship factor calculator 212 can be applied to the selected dataset features to calculate a factor for each selected categorical feature that represents a level of information the categorical feature explains in relation to the continuous feature. The insight incorporator 214 can take as input a deviation factor and a relationship factor for each categorical feature and calculate an insight score 216, for each categorical feature, that reflects the relationship of the categorical feature to the continuous feature.

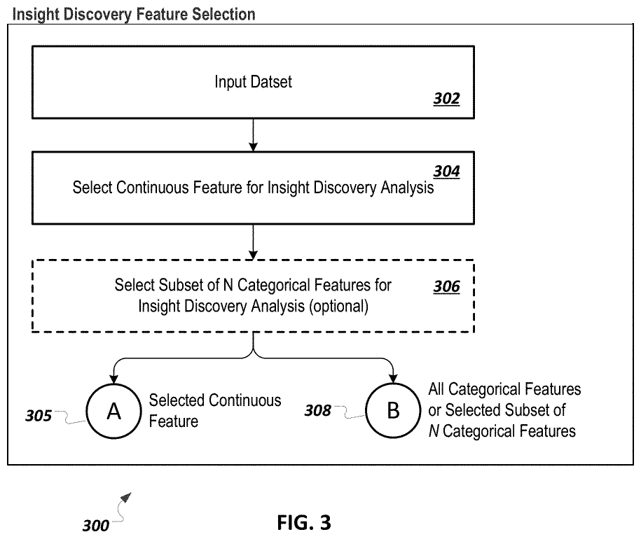

FIG. 3 illustrates an example feature selector 300. The feature selector 300 can be the feature selector 208 described above with respect to FIG. 2, for example. The feature selector 300 can receive an input dataset 302 (e.g., the input dataset 202). The input dataset 302 can be a structured form of data in a tabular format. Within the tabular format, columns can represent labelled features and rows can hold the values of the labelled features relative to their respective column. The labelled features can represent continuous or categorical data.

At 304, a continuous feature is selected for insight discovery analysis from the input dataset 302. The selected continuous feature is provided as a first output 305. At 306, as an optional step, a subset of categorical features is optionally selected for insight discovery analysis from the available categorical features within the input dataset 302. If no subset selection is performed, all categorical features within the input dataset are selected for insight discovery analysis. A second output 308 can be either all N categorical features or a selected subset of categorical features. The first output 305 and the second output 308 can represent a constrained dataset that can be passed to the insight discovery analysis framework 206, for example.

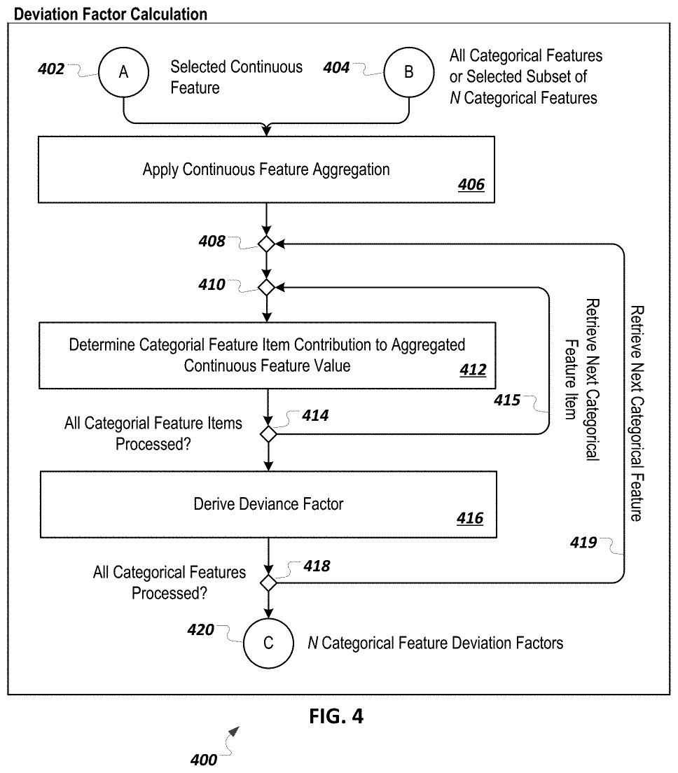

FIG. 4 illustrates an example deviation factor calculator 400. A first input 402 is a selected continuous feature. A second input 404 is a subset (or a full set) of categorical features.

At 406, an aggregation is applied to the continuous feature, grouping all row values of the continuous feature to form a single aggregated value. Examples of aggregate functions include sum, count, minimum, maximum, and average. A particular aggregation type to use can be predefined (e.g., defaulted) or can be selected.

At 408, a first iteration loop is initiated to iterate over each categorical feature. For a first iteration, a first categorical feature is selected. At 410, a second iteration loop is initiated to iterate, for a given categorical feature, the categories within the categorical feature. For a first iteration, a first category of the first categorical feature can be selected.

At 412, for a current category (e.g., categorical feature item), the selected aggregation is applied to aggregate the continuous feature values that exist within the categorical feature item to determine a categorical feature item contribution to the aggregated continuous feature value.

At 414, a determination is made as to whether there are additional unprocessed categories of the current categorical feature. If not all of the categories have been processed for the categorical feature, a next category is selected at 415.

At 416, after all categories of the categorical feature have been processed, a deviance factor is calculated for the current categorical feature based on the categorical feature item contributions to the aggregated continuous feature value of the categories within the categorical feature. Deviance factor determination is discussed in more detail below.

At 418, a determination is made as to whether there are additional unprocessed categorical features. If not all of the categorical features have been processed, a next categorical feature is selected, at 419.

At 420, once all categorical features have been processed, an output 420, of a set of deviation factors for the categorical features, can be provided (e.g., to an insight incorporator, as described below).

In further detail, the categorical feature item contributions discussed above can be utilized in derivation of deviance factors for the categorical features. An algorithm that can be used to derive a deviation factor is shown below:

$${DeviationFactor}_{categorical feature} = \frac{α - {average}_{category contribution}}{{average}_{category contribution}}$$

where:

$$a = \{ \begin{matrix}\begin{matrix}max ( \{ f ( x ) : x = category {contribution}_{i} , … , \\ category {contribution}_{n} ) \} , {average}_{category contribution} \geq 0\end{matrix} \\ \begin{matrix}min ( \{ f ( x ) : x = category {contribution}_{i} , … , \\ category {contribution}_{n} ) \} , {average}_{category contribution} < 0\end{matrix}\end{matrix}$$

That is, a value a can be set to either a maximum or a minimum of categorical feature item contributions based on whether an average of the categorical feature item contributions is positive or negative, respectively. A deviation factor can thus represent how far a largest (negative or positive) value deviates from an average value for the categorical feature. In other words, a deviation factor for a categorical feature can represent how far a category with a largest value deviates from the average of all categories for the categorical feature.

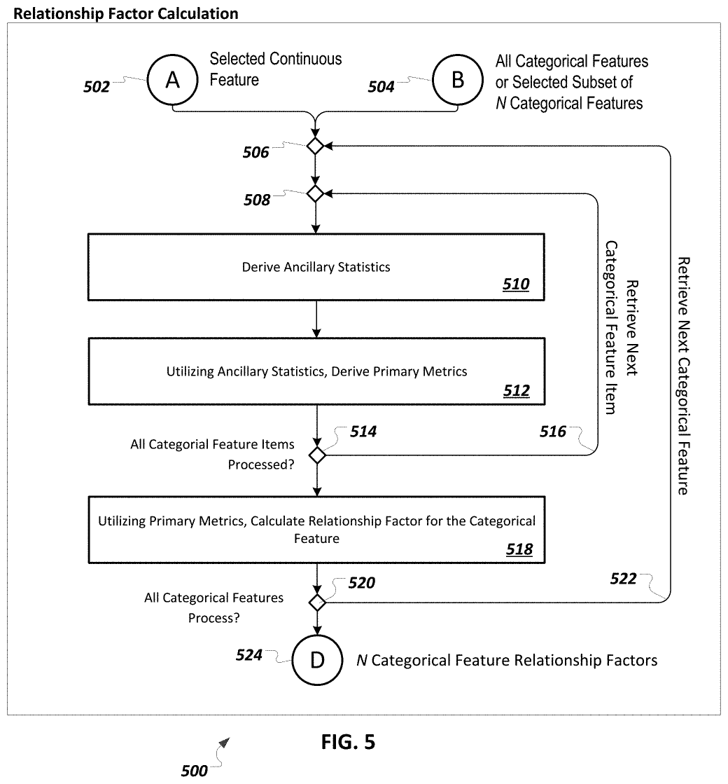

FIG. 5 illustrates an example relationship factor calculator 500. A first input 502 is a selected continuous feature. A second input 504 is a subset (or a full set) of categorical features. At 506, a first iteration loop is initiated, to iterate over each categorical feature. For a first iteration, a first categorical feature is selected. At 508, a second iteration loop is initiated to iterate, for a given categorical feature, the categories within the categorical feature. For a first iteration, a first category of the first categorical feature can be selected as a current category.

At 510, ancillary statistics are generated for the current category. Ancillary statistics for the current category can include a mean, variance, variance relative to the dataset, and a record count.

The mean for the category can be computed using a formula of:

$$\overline{{x}_{c a t egory}} = \frac{{\sum }_{i = 1}^{n} {x}_{i}}{n}$$

where x is the value of the continuous measure where the categorical feature equals the category and n is the number of records where the categorical feature equals the category.

The variance for the category can be computed using a formula of:

$$va {r}_{c a t egory} ( x ) = \frac{{\sum }_{i = 1}^{n} {( {x}_{i} - {\overline{x}}_{c a t e g o r y} )}^{2}}{n - 1}$$

where x̅ is the mean for the category, x is the value of the continuous measure where the categorical feature equals the category of interest, and n is the number of records where the categorical feature equals the category.

The variance for the category relative to the dataset can be computed using a formula of:

$$v a {r}_{category relative} ( x ) = \frac{{\sum }_{i = 1}^{n} {( {x}_{i} - \overline{{x}_{d s}} )}^{2}}{n - rela t i v e s a m p l e}$$

where x̅_̅{̅d̅s̅}̅ is the mean of the continuous measure for the entire dataset, x is the value of the continuous measure where the categorical feature equals the category of interest, n is the number of records where the categorical feature equals the category, and relativesample is

$$\frac{n}{{n}_{d s}}$$

where n_{ds} is the number of records in the entire dataset.

The record count of the category reflects a count of rows in which the category occurs, and can be computed using a formula of:

recordcount_{category}

$$( x ) = {\sum }_{i = i}^{n} \{ \begin{matrix}0 & {s}_{i} \neq x \\ 1 & {s}_{i} = x\end{matrix}$$

where x is the category to be counted and sᵢ is a category at row i.

At 512, primary metrics are derived for the current category using the ancillary metrics for the category. Primary metrics can include a Sum of Square Residual (SSR) and Sum of Square Total (SST).

The SSR for a category can be computed using a formula of:

SSR_{category}(x)=var_{category}(x)*(recordcount_{category}(x)−(1−relativesample_{category(x)})).

The SST for a category can be computed using a formula of:

SST_{category}=var_{category relative}(x)*recordcount_{category}(x).

At 514, a determination is made as to whether there are additional unprocessed categories of the current categorical feature. If not all of the categories have been processed for the categorical feature, a next category is selected, at 516.

At 518, after all categories of the current categorical feature have been processed, a relationship factor is calculated for the current categorical feature. A first step in calculating the relationship factor can include computing a principal relationship factor (PRF) that reflects a relationship between the categorical feature and the continuous feature. The principal relationship factor can be computed using a formula of:

$$P R {F}_{categorical feature} = 1 - ( \frac{{\sum }_{i = 1}^{n} S S {R}_{category i}}{{\sum }_{i = 1}^{n} S S {T}_{category i}} ) .$$

For the principal relationship factor, a value near 1 suggests a strong relationship exists between the categorical feature and the continuous feature, with factor value of near zero suggesting the absence of a relationship.

A second step in calculating the relationship factor can include computing an adjusted principal relationship factor (APRF) for the categorical feature that adjusts for the cardinality of the categorical feature. The adjusted principal relationship factor can be computed using a formula of:

$$apr {f}_{categorical feature} = 1 - ( \frac{( 1 - P R {F}_{categorical feature} ) * ( {n}_{d s} - 1 )}{{n}_{d s} - {n}_{c a t e g o ries} - 1} ) ,$$

where n_{ds} is the number of records in the dataset and n_{categories} is the cardinality of the categorical feature. Similar to the principal relationship factor, for the adjusted principal relationship factor, a value near 1 suggests that a strong relationship exists between the categorical feature and the continuous feature, with a factor value of near zero suggesting the absence of a relationship.

Utilizing the adjusted principal relationship factor, the relationship factor is then calculated for the categorical feature. The algorithm to produce the relationship factor can be defined as:

$$relationship {factor}_{categorical feature} = \{ \begin{matrix}1 , for {aprf}_{( categorical feature )} = 1 \\ 1 , for {aprf}_{( categorical feature )} < 0 \\ 1 + for {aprf}_{( categorical feature )} , for 0 \leq {aprf}_{( categorical feature )} < 1.\end{matrix}$$

For the relationship factor, a value near one suggests the absence of a relationship between the categorical feature item and the continuous feature, with a factor value of near two suggesting a strong relationship.

At 520, a determination is made as to whether there are additional unprocessed categorical features. If not all of the categorical features have been processed, a next categorical feature is selected, at 522, and processed (e.g., at steps 506 to 518).

At 524, once all categorical features have been processed, an output 524, of a set of relationship factors for the categorical features, can be provided (e.g., to an insight incorporator, as described below).

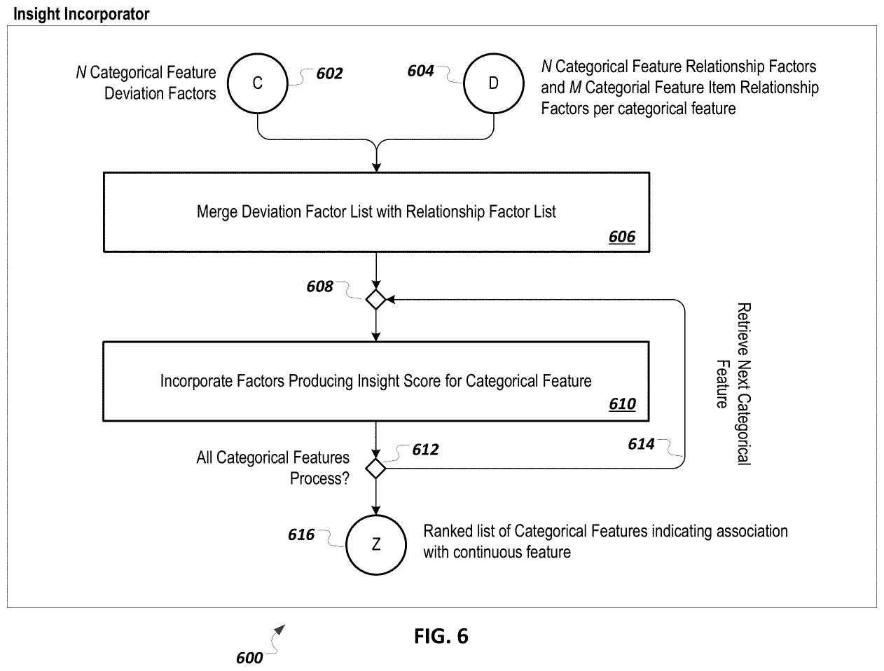

FIG. 6 illustrates an example insight incorporator 600. A first input 602 for the insight incorporator 600 is a list of categorical feature deviation factors (e.g., as provided by the deviation factor calculator 210). A second input 604 includes a list of categorical feature relationship factors and categorical feature item relationship factors for each categorical feature.

At 606, the first input 602 and the second input 604 are merged, according to categorical feature, to create a merged list of inputs. At 608, an iteration is started that loops over each item in the merged list. For instance, inputs for a first categorical feature can be obtained from the merged list of inputs. The first categorical feature can be a current categorical feature being processed in the iteration.

At 610, a deviation factor for the current categorical feature and a relationship factor for the current categorical feature are incorporated into an insight score for the current categorical feature. Different approaches can be used during incorporation. For instance, the insight score for the current categorical feature can be determined by multiplying the deviation factor for the current categorical feature by the relationship factor for the current categorical feature.

At 612, a determination is made as to whether all categorical features have been processed. If not all categorical features have been processed, inputs are retrieved, at 614, from the merged list of inputs, for a next categorical feature. At 610, the deviation factor for the next categorical feature and the relationship factor for the next categorical feature are incorporated into an insight score for the next categorical feature.

Once all categorical features have been processed, the insight incorporator 600 can provide (e.g., to a user or to an application or system) a ranked list 616 of categorical features indicating association with the continuous feature. The ranked list 616 can rank the categorical features in terms of a level of insight and relationship information in relation to the selected continuous feature. Categorical features that have a stronger informational relationship with the continuous feature can be ranked higher in the ranked list 616 than other categorical features.

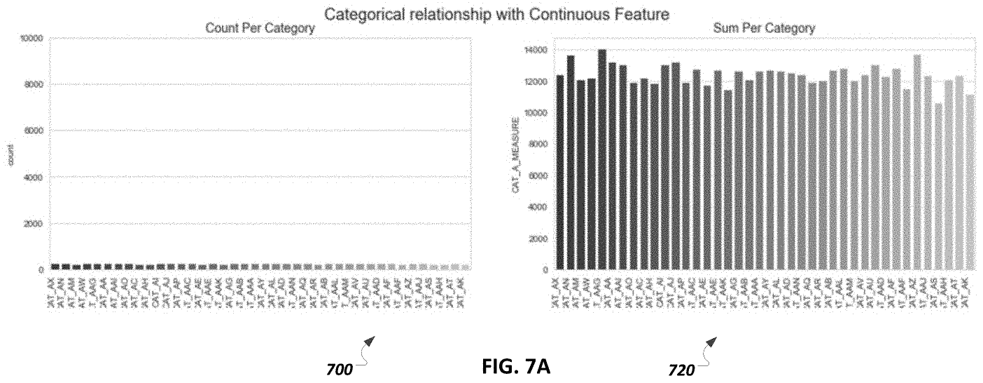

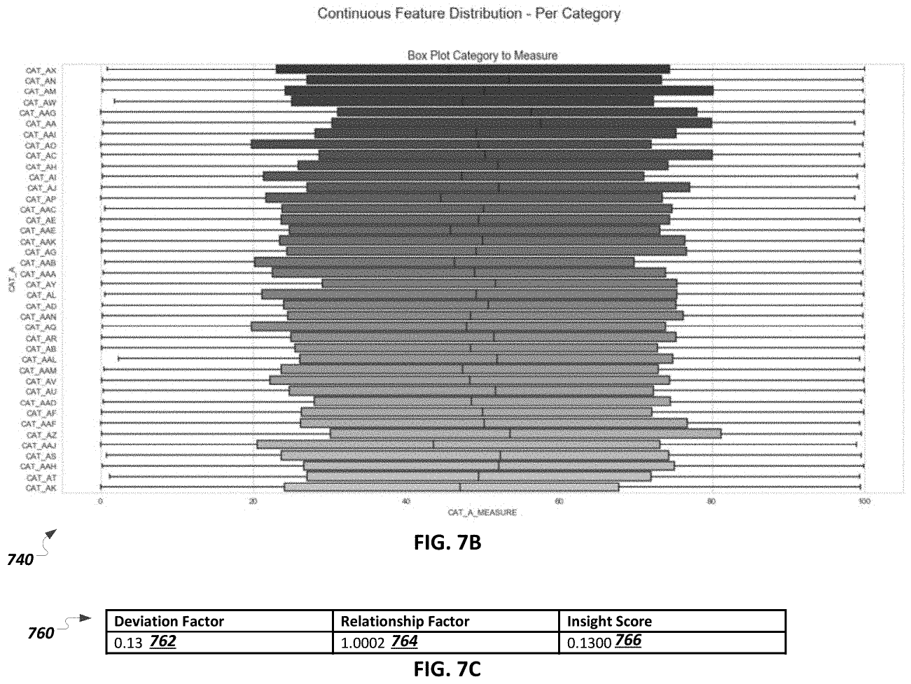

The insight algorithm can be applied to various datasets. For instance, FIGS. 7A-7C, 8A-8C, 9A-9C, 10A-10C, and 11A-11C illustrate results from example executions of the insight algorithm on five example datasets. Each example dataset used during the example executions of the insight algorithm include a first column representing a continuous feature and a second column representing a categorical feature, with each row representing an entry of a value for a specific category. Possible values for the continuous feature column can be in a range one to one hundred, inclusive. The categorical feature column can include values from among a predefined set of distinct categories (e.g., 40 categories). Results from running the insight algorithm on the example datasets vary, depending on amounts of deviation and existence (or lack) of relationships between categories and the continuous feature.

FIG. 7A illustrates a count per category graph 700 and a continuous feature value sum per category graph 720 for a first example dataset. As shown in the count per category graph 700, each category is equally likely to appear. Moreover, as shown in the continuous feature value sum per category graph 720, each categorical sum of continuous values is similar (e.g., similar within a threshold amount).

FIG. 7B illustrates a continuous feature distribution per category graph 740. The continuous feature distribution per category graph 740 does not depict any clear relationship between categories and the continuous feature, for the first example dataset.

FIG. 7C is a table 760 illustrating results from executing the insight algorithm on the first example dataset. For instance, for the categorical feature, a deviation factor 762 of 0.13, a relationship factor 764 of 1.0002, and an insight score 766 of 0.1300 have been computed.

The deviation factor 762 being substantially close to zero indicates a relatively small amount of deviation. The relationship factor 764 being substantially close to the value of one indicates that the relationship factor 764 reasonably identifies and represents the absence of a relationship existing between the categorical feature and the continuous feature. Furthermore, given that for the first example dataset, aggregated values of the continuous feature are similar across each category (e.g., suggesting no significant deviational behavior), the deviation factor 762 being substantially close to zero is appropriate. An output product of the deviation factor 762 and the relationship factor 764 result in the insight score 766 being substantially close to zero, which accurately and collectively reflects the low deviation and the categorical feature's insignificant relationship with the continuous feature.

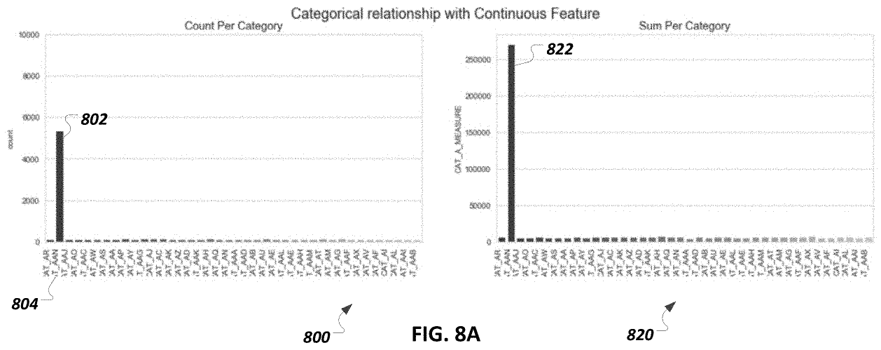

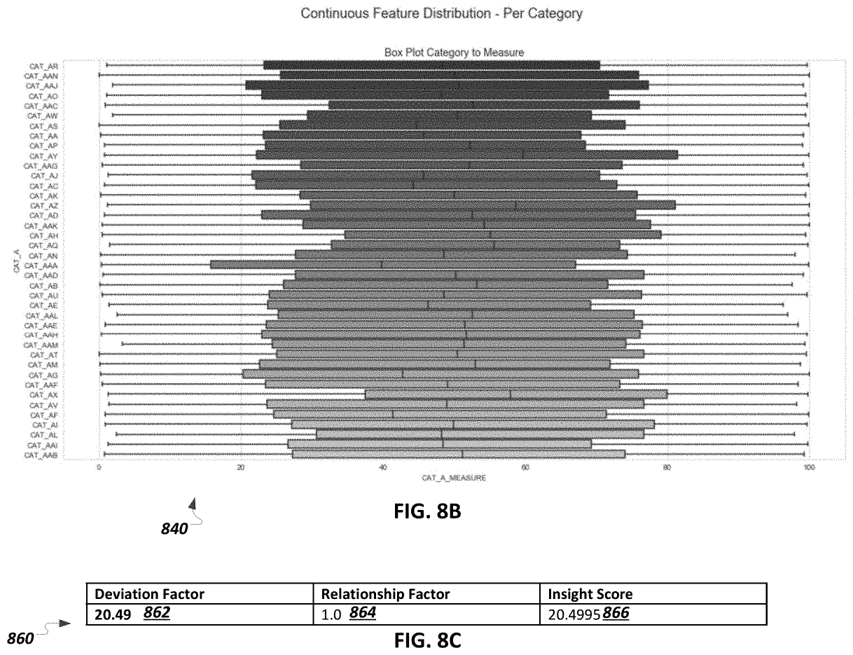

FIG. 8A illustrates a count per category graph 800 and a continuous feature value sum per category graph 820 for a second example dataset. As shown by a category plot 802 in the count per category graph 800, a category 804 dominates the second example dataset, with the category 804 representing approximately 53% of the records in the second example dataset. Moreover, as shown by a plot 822 in the continuous feature value sum per category graph 820, a sum of continuous values for the category 804 is significantly greater than all other categories.

FIG. 8B illustrates a continuous feature distribution per category graph 840. The continuous feature distribution per category graph 840 does not depict any clear relationship between categories and the continuous feature, for the second example dataset.

FIG. 8C is a table 860 illustrating results from executing the insight algorithm on the second example dataset. For instance, for the categorical feature, a deviation factor 862 of 20.49, a relationship factor 864 of 1.0, and an insight score 866 of 20.4995 have been computed.

The relationship factor 864 computed as 1.0 reasonably identifies and represents the absence of a relationship existing between the categorical feature and the continuous feature. Furthermore, the second example dataset includes a pattern of aggregated values of the continuous feature for one category (the category 804) being significantly greater than for all other categories. Accordingly, the deviation factor 862 is substantially greater than, for example, the deviation factor 762.

An output product of the deviation factor 862 and the relationship factor 864 result in the insight score 866. The insight score 866 matching the deviation factor 862 suggests that while a significant deviation factor may be present in the second example dataset, without an informational relationship existing with the continuous feature, a categorical feature relationship with the continuous feature is insignificant (thus, the insight score 866 is not raised from the deviation factor 862).

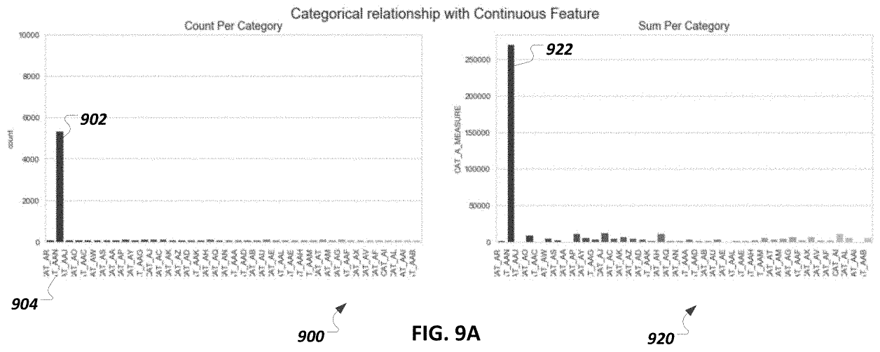

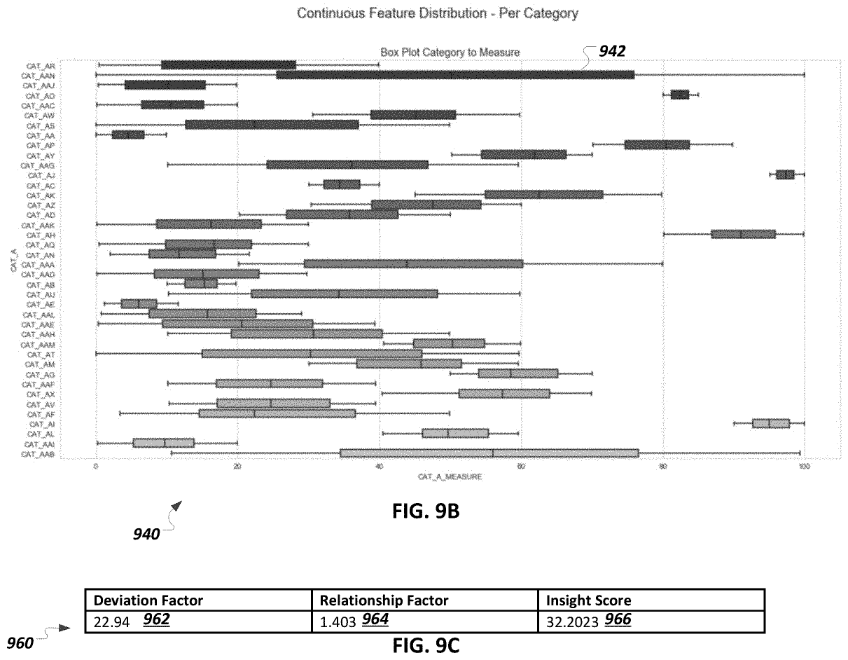

FIG. 9A illustrates a count per category graph 900 and a continuous feature value sum per category graph 920 for a third example dataset. As shown by a category plot 902 in the count per category graph 900, a category 904 dominates the second example dataset, with the category 904 representing approximately 53% of the records in the third example dataset. Moreover, as shown by a plot 922 in the continuous feature value sum per category graph 920, a sum of continuous values for the category 904 is significantly greater than all other categories.

FIG. 9B illustrates a continuous feature distribution per category graph 940. As shown by a plot 942 for the category 904, the continuous feature distribution per category graph 940 does not depict any clear relationship between the category 904 and the continuous feature. The continuous feature distribution per category graph 940 illustrates varying degrees of relationship with the continuous feature for other categories (e.g., where a relationship strength generally differs for each category).

FIG. 9C is a table 960 illustrating results from executing the insight algorithm on the third example dataset. For instance, for the categorical feature, a deviation factor (962) of 22.94, a relationship factor (964) of 1.403, and an insight score (966) of 32.2023 have been computed. The results illustrate that the relationship factor 964 reasonably identifies and represents the varying degrees of informational relationships existing between the categories and the continuous feature. Furthermore, the results, specifically the deviation factor 962, reflect that the aggregated value of the continuous feature for one category (e.g., the category 904) is significantly greater than all other categories. An output product of the deviation factor 962 and the relationship factor 964 result in the insight score 966 that accurately reflects the deviation and the categorical features relationship with the continuous feature.

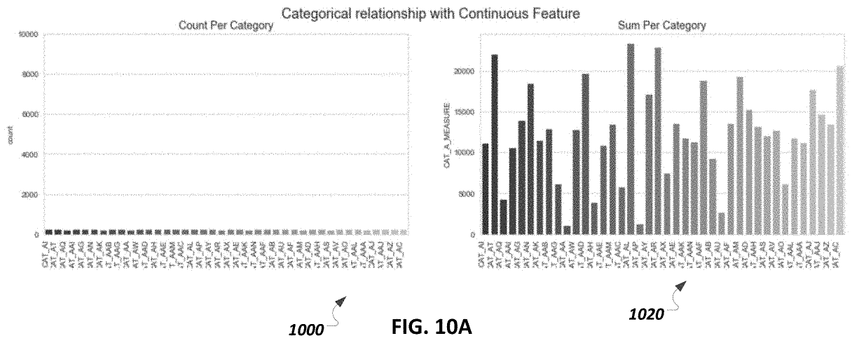

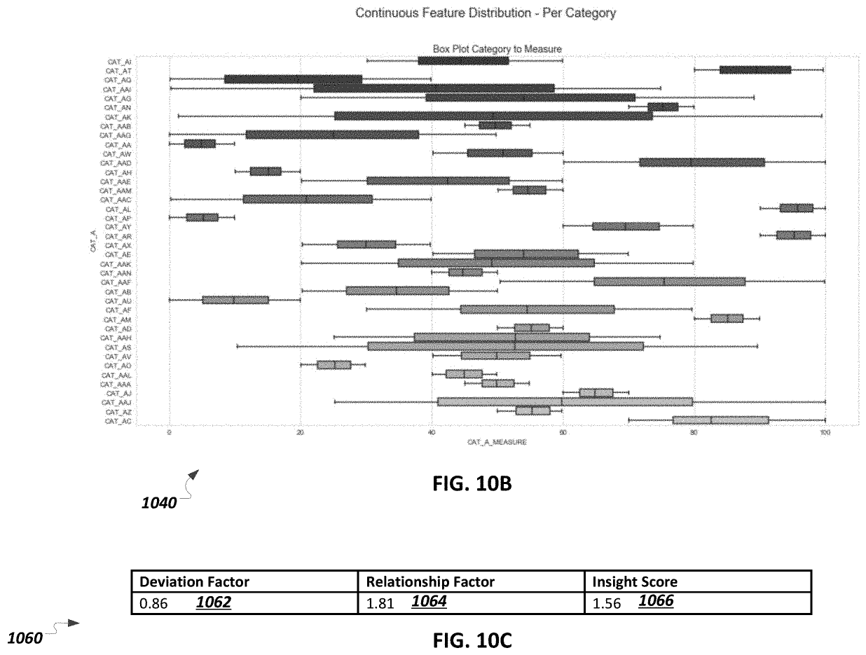

FIG. 10A illustrates a count per category graph 1000 and a continuous feature value sum per category graph 1020 for a fourth example dataset. As shown in the count per category graph 1000, each category is equally likely to appear. Moreover, as shown in the continuous feature value sum per category graph 1020, the sum of continuous values for each category varies between the categories.

FIG. 10B illustrates a continuous feature distribution per category graph 1040. The continuous feature distribution per category graph 1040 illustrates that various degrees of relationships exist between each category and the continuous feature.

FIG. 10C is a table 1060 illustrating results from executing the insight algorithm on the fourth example dataset. For instance, for the categorical feature, a deviation factor 1062 of 0.86, a relationship factor 1064 of 1.81, and an insight score 1066 of 1.56 have been computed. The results indicate that the relationship factor 1064 reasonably identifies and represent the informational relationships existing between the categories and the continuous feature. Furthermore, the deviation factor 1062 indicates no significant deviational behavior. An output product of the deviation factor 1062 and the relationship factor 1064 result in the insight score 1066 that accurately reflects 1) the lack of deviation; and 2) that the categorical feature has a relationship with the continuous feature.

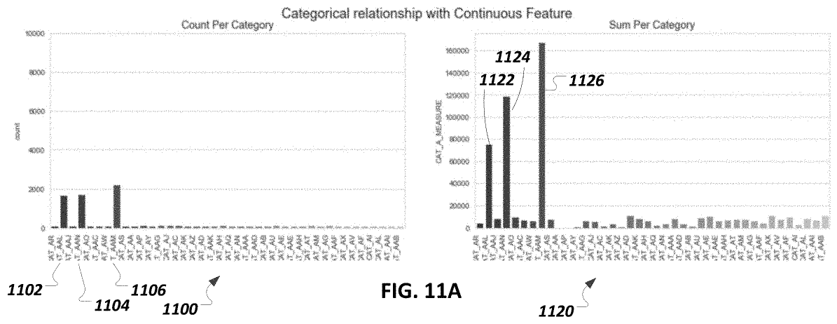

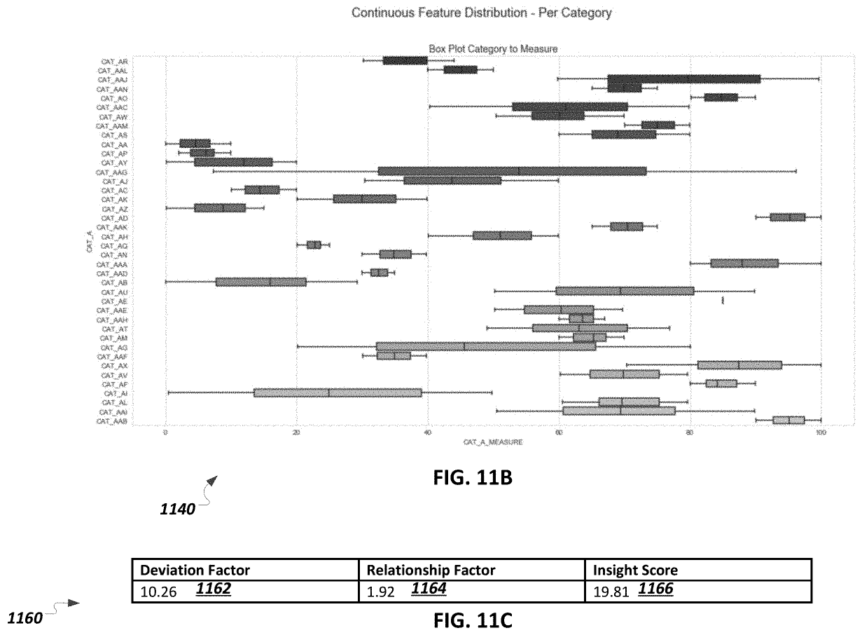

FIG. 11A illustrates a count per category graph 1100 and a continuous feature value sum per category graph 1120 for a fifth example dataset. As shown in the count per category graph 1100, a category 1102, a category 1104, and a category 1106 dominate the fifth example dataset, with the category 1102 representing approximately 22% of the records, and the category 1104 and the category 1106 each representing approximately 16.8% of the records. The remaining categories are equally likely to appear. Moreover, as shown in plots 1122, 1124, and 1124 in the continuous feature value sum per category graph 1120, the sums of continuous values for the category 1102, the category 1104, and the category 1106 are significantly greater than sums for the other categories.

FIG. 11B illustrates a continuous feature distribution per category graph 1140. The continuous feature distribution per category graph 1140 illustrates that various degrees of relationships exist between each category and the continuous feature.

FIG. 11C is a table 1160 illustrating results from executing the insight algorithm on the fifth example dataset. For instance, for the categorical feature, a deviation factor (1162) of 10.26, a relationship factor (1164) of 1.92, and an insight score (1166) of 19.81 have been computed. The results indicate that the relationship factor 1164 reasonably represents the informational relationships existing between the categorical feature and the continuous feature. Furthermore, the deviation factor 1162 reflects that the aggregated value of the continuous feature for several categories is significantly greater than most of the other categories. An output product of the deviation factor 1162 and the relationship factor 1164 results in the insight score 1166 that accurately reflects the deviation and the categorical features relationship with the continuous feature.

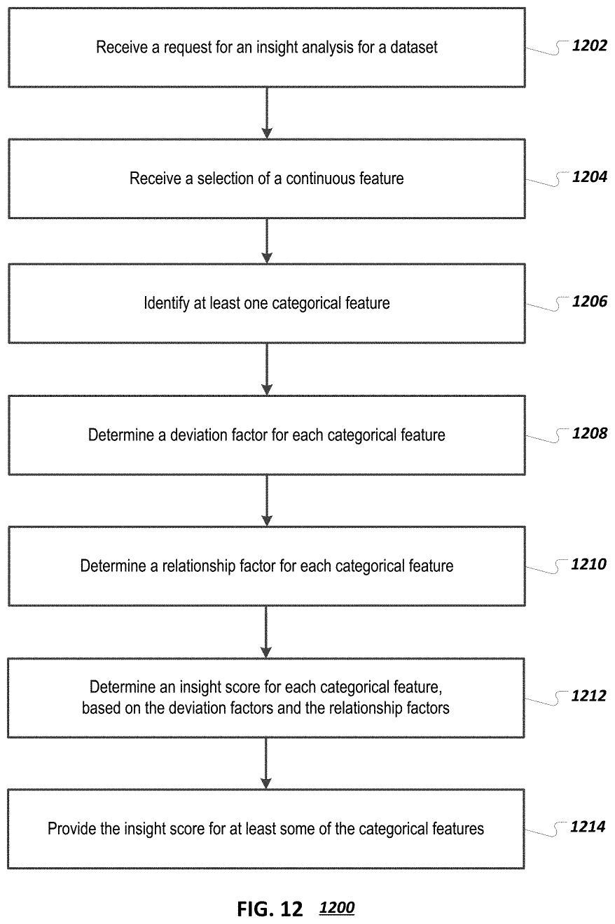

FIG. 12 is a flowchart of an example method for generating insights based on numeric and categorical data. It will be understood that method 1200 and related methods may be performed, for example, by any suitable system, environment, software, and hardware, or a combination of systems, environments, software, and hardware, as appropriate. For example, one or more of a client, a server, or other computing device can be used to execute method 1200 and related methods and obtain any data from the memory of a client, the server, or the other computing device. In some implementations, the method 1200 and related methods are executed by one or more components of the system 100 described above with respect to FIG. 1. For example, the method 1200 and related methods can be executed by the insight analysis framework 116 of FIG. 1.

At 1202, a request is received for an insight analysis for a dataset. The dataset includes at least one continuous feature and at least one categorical feature. Continuous features are numerical features that represent features that can have any value within a range of values and categorical features are enumerated features that can have a value from a predefined set of values.

At 1204, a selection is received of a first continuous feature for analysis.

At 1206, at least one categorical feature is identified for analysis. All categorical features can be identified or a subset of categorical features can be received.

At 1208, a deviation factor is determined for each identified categorical feature. A deviation factor represents a level of deviation in the dataset between categories of the categorical feature in relation to the continuous feature.

At 1210, a relationship factor is determined for each identified categorical feature. A relationship factor represents a level of informational relationship between the categorical and continuous feature.

At 1212, an insight score is determined for each categorical feature, based on the determined deviation factors and the determined relationship factors. An insight score combines the deviation factor and the relationship factor for the categorical feature. The level of informational relationship for a categorical feature can indicate how well the categorical feature predicts values of the continuous feature. An insight score for a given categorical feature can be determined by multiplying the deviation factor for the categorical feature by the relationship factor for the categorical feature. A higher insight score for a categorical feature represents a higher level of insight in relation to the continuous feature.

At 1214, insight scores are provided for at least some of the categorical features. The insight scores can be ranked and at least some of the ranked insight scores can be provided.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method comprising:
receiving a request for an insight analysis for a dataset, wherein the dataset includes at least one continuous feature and at least one categorical feature, wherein continuous features are numerical features that represent features that can have any value within a range of values and wherein categorical features are enumerated features that can have a value from a predefined set of values;
receiving a selection of a first continuous feature for analysis;
identifying at least one categorical feature for analysis;
determining, for each identified categorical feature, a deviation factor that represents a level of deviation in the dataset between categories of the categorical feature in relation to the continuous feature;
determining, for each identified categorical feature, a relationship factor that represents a level of informational relationship between the categorical and continuous feature;
determining, based on the determined deviation factors and the determined relationship factors, an insight score, for each identified categorical feature, that combines the deviation factor and the relationship factor for the categorical feature; and
providing the insight score for at least some of the identified categorical features.

2. The method of claim 1, wherein the level of informational relationship for a categorical feature indicates how well the categorical feature predicts values of the continuous feature.

3. The method of claim 1, further comprising:
ranking categorical features by insight score; and
providing ranked insight scores.

4. The method of claim 1, wherein identifying the at least one categorical feature comprises receiving a selection of a subset of the categorical features within the dataset.

5. The method of claim 1, wherein identifying the at least one categorical feature comprises identifying all categorical features within the dataset.

6. The method of claim 1, wherein determining the insight score for a given categorical feature comprises multiplying the deviation factor for the categorical feature by the relationship factor for the categorical feature.

7. The method of claim 1, wherein a higher insight score for a categorical feature represents a higher level of insight in relation to the continuous feature.

8. The method of claim 1, wherein the deviation factor for a categorical feature is based on category contributions of categories of the categorical feature to an aggregated continuous feature value.

9. The method of claim 8, wherein the deviation factor for a categorical feature represents how much a category of the categorical feature with a largest category contribution deviates from the average of all category contributions for the categorical feature.

10. The method of claim 1, wherein the relationship factor for a categorical feature is based on variance factors for categories of the categorical feature.

11. The method of claim 10, wherein the relationship factor for a categorical feature is based on sum of square residuals and sum of square totals for categories of the categorical feature.

12. The method of claim 1, wherein the relationship factor for a categorical feature is based on the cardinality of the categorical feature.

13. A system comprising:
one or more computers; and
a computer-readable medium coupled to the one or more computers having instructions stored thereon which, when executed by the one or more computers, cause the one or more computers to perform operations comprising:
receiving a request for an insight analysis for a dataset, wherein the dataset includes at least one continuous feature and at least one categorical feature, wherein continuous features are numerical features that represent features that can have any value within a range of values and wherein categorical features are enumerated features that can have a value from a predefined set of values;
receiving a selection of a first continuous feature for analysis;
identifying at least one categorical feature for analysis;
determining, for each identified categorical feature, a deviation factor that represents a level of deviation in the dataset between categories of the categorical feature in relation to the continuous feature;
determining, for each identified categorical feature, a relationship factor that represents a level of informational relationship between the categorical and continuous feature;
determining, based on the determined deviation factors and the determined relationship factors, an insight score, for each identified categorical feature, that combines the deviation factor and the relationship factor for the categorical feature; and
providing the insight score for at least some of the identified categorical features.

14. The system of claim 13, wherein the level of informational relationship for a categorical feature indicates how well the categorical feature predicts values of the continuous feature.

15. The system of claim 13, wherein the operations further comprise:
ranking categorical features by insight score; and
providing ranked insight scores.

16. The system of claim 13, wherein identifying the at least one categorical feature comprises receiving a selection of a subset of the categorical features within the dataset.

17. A computer program product encoded on a non-transitory storage medium, the product comprising non-transitory, computer readable instructions for causing one or more processors to perform operations comprising:
receiving a request for an insight analysis for a dataset, wherein the dataset includes at least one continuous feature and at least one categorical feature, wherein continuous features are numerical features that represent features that can have any value within a range of values and wherein categorical features are enumerated features that can have a value from a predefined set of values;
receiving a selection of a first continuous feature for analysis;
identifying at least one categorical feature for analysis;
determining, for each identified categorical feature, a deviation factor that represents a level of deviation in the dataset between categories of the categorical feature in relation to the continuous feature;
determining, for each identified categorical feature, a relationship factor that represents a level of informational relationship between the categorical and continuous feature;
determining, based on the determined deviation factors and the determined relationship factors, an insight score, for each identified categorical feature, that combines the deviation factor and the relationship factor for the categorical feature; and
providing the insight score for at least some of the identified categorical features.

18. The computer program product of claim 17, wherein the level of informational relationship for a categorical feature indicates how well the categorical feature predicts values of the continuous feature.

19. The computer program product of claim 17, wherein the operations further comprise:
ranking categorical features by insight score; and
providing ranked insight scores.

20. The computer program product of claim 17, wherein identifying the at least one categorical feature comprises receiving a selection of a subset of the categorical features within the dataset.
